(19) United States
(12) Patent Application Publication
(10) Pub. No.: US 2008/0082412 A1
(43) Pub. Date: Apr. 3, 2008

(54) Limited inventory module for a customer service and support system

(75) Inventors: Deborah Tallyn, Lafayette, CA (US); Deborah McCarthy, University City, MO (US); Patricia Moreland, Union, MO (US); John Zaloudek, St. Louis, MO (US)

Correspondence Address: GREENBLUM & BERNSTEIN, P.L.C., 1950 ROLAND CLARKE PLACE, RESTON, VA, 20191, US

(73) Assignee: AT & T Knowledge Ventures, LP., Reno, NV (US)

(21) Appl. No.: 11/540,759

(22) Filed: Oct. 2, 2006

(51) Int. Cl. G06Q 30/00

(52) U.S. Cl. 705/14

(57) ABSTRACT

The sale of limited directory advertising space is coordinated. An indication of an availability status of the limited directory advertising space is obtained. An order for the limited directory advertising space is received. The order for the limited directory advertising space is accepted when the availability status indicates that the limited directory advertising space is available. The order for the limited directory advertising space is refused when the availability status indicates that the limited directory advertising space is unavailable. The availability status for the limited directory advertising space is changed when the order is accepted.

### BACKGROUND

1. Field of the Disclosure

The present disclosure relates to a customer service and support system (CSS). More particularly, the present disclosure relates to a limited inventory module for a customer service and support system to coordinate the sale of limited inventory items.

2. Background Information

Limited inventory items are goods or services that are offered for sale in limited quantities. For example, a phone directory such as the Yellow Pages or other printed periodical may include as much advertising space on interior pages as can be sold. As more advertising space is sold, the design for the phone directory is merely expanded to include more interior pages. However, a phone directory has only a single front cover and a single back cover, such that advertising for the front and back covers is limited in quantity. Quantity limitations may also exist for internet sites such as the internet version of the Yellow Pages, where only limited space exists for advertising on particular pages. Additionally, a seller may have the ability to sell some limited inventory items in quantities larger than actually offered, but may limit the actual quantity by agreement with buyers as part of a sales strategy.

Current sales and support systems allow the same limited inventory to be sold to different customers. This situation may occur when information regarding the earlier sale is not available to prevent a later sale. The information of the earlier sale may not be available due to reporting or processing delays or failures.

Limited inventory may also be oversold when a sales and support system used by a sales representative making the first sale is not integrated with a sales and support system used by a sales representative making the second sale. For example, a telecommunications service provider may sell print and internet phone directory advertising through multiple channels, such as a national sales channel and multiple local sales channels. If the sales and support systems that support these channels are not integrated, sales representatives in one channel may not be able to determine that a limited inventory item has been sold in another channel.

When a limited inventory item is sold more than once, one of the sales must be cancelled. Such cancellations may cause customer discontent. Additionally, such cancellations divert sales representatives from selling items to other customers. In many cases, it may not be possible to recapture lost revenue. Additionally, some sales representatives may be hesitant to pitch limited inventory items due to potential problems such as those described above.

The problems described above may results in lost revenue, customer dissatisfaction, improper billing, and improper revenue calculation and projection.

### BRIEF DESCRIPTION OF THE DRAWINGS

FIG. 1 shows an exemplary general computer system that includes a limited inventory module for a customer service and support system, according to an aspect of the present disclosure;

FIG. 2 shows a network for implementing a customer service and support system that includes a limited inventory module for the customer service and support system, according to an aspect of the present disclosure;

FIG. 3 shows an exemplary method of using a limited inventory module for a customer service and support system, according to an aspect of the present disclosure;

FIG. 4 shows another exemplary method of using a limited inventory module for a customer service and support system, according to an aspect of the present disclosure;

FIG. 5 shows an exemplary screenshot displayed to a user using a limited inventory module for a customer service and support system, according to an aspect of the present disclosure;

FIG. 6 shows another exemplary screenshot displayed to a user using a limited inventory module for a customer service and support system, according to an aspect of the present disclosure;

FIG. 7 shows another exemplary screenshot displayed to a user using a limited inventory module for a customer service and support system, according to an aspect of the present disclosure; and

FIG. 8 shows another exemplary screenshot displayed to a user using a limited inventory module for a customer service and support system, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, a method of coordinating sales of limited directory advertising space is provided. An indication of an availability status of the limited directory advertising space is obtained. An order for the limited directory advertising space is received. The order for the limited directory advertising space is accepted when the availability status indicates that the limited directory advertising space is available. The order for the limited directory advertising space is refused when the availability status indicates that the limited directory advertising space is unavailable. The availability status for the limited directory advertising space is changed when the order is accepted.

According to another aspect of the present disclosure, the availability status is changed to a reserved status when an order is initially accepted.

According to a further aspect of the present disclosure, acceptance of the accepted order for the limited directory advertising space is confirmed.

According to yet another aspect of the present disclosure, the availability status is changed to an unavailable status when the accepted order for the limited directory advertising space is confirmed as accepted.

According to another aspect of the present disclosure, the acceptance of the accepted order is confirmed when the order is placed earlier than another order for the limited directory advertising space.

According to a further aspect of the present disclosure, the limited directory advertising space includes advertising capacity for a printed periodical.

According to yet another aspect of the present disclosure, the availability status of the limited directory advertising space is retrieved using a machine capable of executing a set of instructions.

According to another aspect of the present disclosure, the indication of the availability status of the limited directory advertising space is displayed on a user interface.

According to a further aspect of the present disclosure, the directory is a telephone directory.

According to yet another aspect of the present disclosure, the indication of the availability status is retrieved from a server by a client, and the order for the limited directory advertising space is sent to the server from the client.

According to another aspect of the present disclosure, the server is configured to accept orders for the limited directory advertising space from any of multiple predetermined clients.

According to a further aspect of the present disclosure, the server limits acceptance of orders to the multiple predetermined clients.

According to yet another aspect of the present disclosure, the order for the limited directory advertising space is accepted based upon a comparison of multiple orders and a determination as to which order to accept based on predetermined criteria indicating a priority of each of the multiple orders.

According to another aspect of the present disclosure, a sale in a first class is made on the condition that an offer for sale in a second class is not received.

According to yet another aspect of the present disclosure, the first class of sales includes sales in a first geographic area, and the second class of sales includes sales in a second geographic area larger than and including the first geographic area.

According to a further aspect of the present disclosure, the first class of sales includes sales at a first compensation amount, and the second class of sales includes sales at a second compensation amount greater than the first compensation amount.

According to another aspect of the present disclosure, an order for the limited directory advertising space is not accepted when the limited directory advertising space is reserved pending a right of renewal for a previous customer.

According to yet another aspect of the present disclosure, a status of the limited directory advertising space is initially changed to a waiting status until a request to change the status of the limited directory advertising space is approved.

According to a further aspect of the present disclosure, a waiting list for the limited inventory item is populated when the limited inventory item is unavailable and another order for the limited inventory item is received.

According to an aspect of the present disclosure, a computer readable medium stores a program that coordinates sales of limited directory advertising space. The computer readable medium includes a limited directory advertising space availability forwarding segment that forwards an indication of an availability status of the limited directory advertising space. An order receiving segment receives an order for the limited directory advertising space. An order placement acceptance segment accepts the order for the limited directory advertising space when the availability status indicates that the limited directory advertising space is available and refuses the order for the limited directory advertising space when the availability status indicates that the limited directory advertising space is unavailable. A status changing segment changes the availability status for the limited directory advertising space when the order is accepted.

According to another aspect of the present disclosure, a limited inventory module for a customer service and support system coordinates sales of limited directory advertising space. A forwarder forwards an indication of an availability status of the limited directory advertising space. A receiver receives an order for the limited directory advertising space. An acceptor accepts the order for the limited directory advertising space when the availability status indicates that the limited directory advertising space is available and refuses the order for the limited directory advertising space when the availability status indicates that the limited directory advertising space is unavailable. A status changer changes the availability status for the limited directory advertising space when the order is accepted.

The present disclosure relates to coordinating the sale of limited inventory items. The limited inventory module described herein may be used with a customer service and support system to support reservations and sales of limited inventory items. The limited inventory module described herein may also be used to verify availability of limited inventory items. The limited inventory module described herein may further be used to limit the sale of limited inventory items.

A limited inventory module is integrated with a customer service and support system to process reservations and sales of limited inventory items. The limited inventory module allows sales representatives to query the customer service and support system while preparing accounts to see if a limited inventory item is available or likely to become available. If available, the limited inventory item can be pitched to a customer, and the reservation and sale of the limited inventory item can be completed. Following the reservation and sale of the limited inventory item, the limited inventory module will restrict reservations and/or sales of the same limited inventory item, and the availability status of the limited inventory item will be updated.

The limited inventory module allows the sales representatives to immediately log a reservation and sale for a customer. The next sales representative who tries to retire a previously reserved or sold item will be blocked. Information will be provided to the next sales representative that the limited inventory item is no longer available, although reservations may still be accepted in case an unavailable limited inventory item later becomes available.

The limited inventory module enables a seller of limited inventory items to track inventory from the beginning of a sales effort, when consideration is first given as to the number and types of limited inventory items that will be made available. The status of limited inventory can be tracked until the end of the sales effort using the limited inventory module.

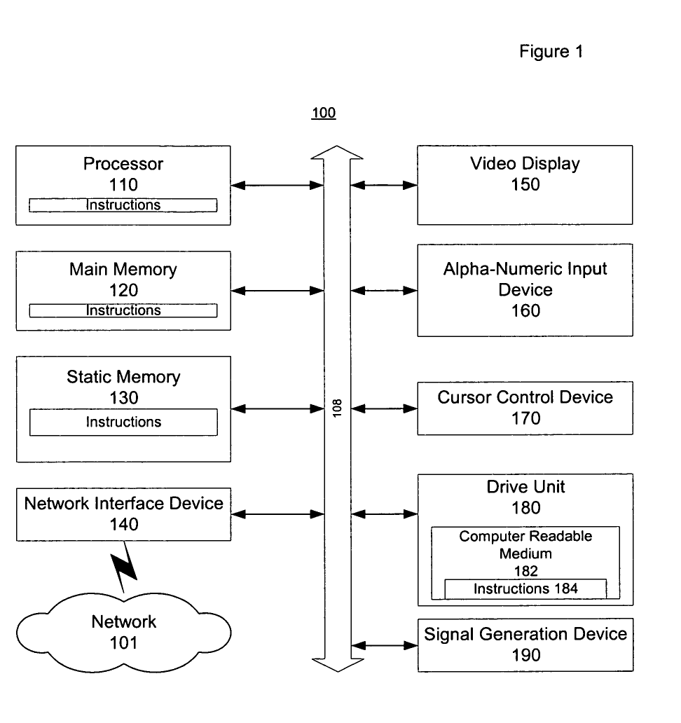

Referring to FIG. 1, an illustrative embodiment of a general computer system, on which a limited inventory module for a customer service and support system can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, as a peer computer system in a peer-to-peer (or distributed) network environment, or in the capacity of a computer system in a web-based multi-tiered network environment. The computer system 100 can also be implemented as or incorporated into various devices, such as a personal computer (PC), a desktop computer, a cell phone, a personal digital assistant (PDA), a mobile device, an internet protocol (IP telephone), a palmtop computer, a laptop computer, a communications device, a wireless telephone, a control system, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term system shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term computer-readable medium includes a single medium or multiple media, such as a centralized or distributed database, and/or associated caches and servers that store one or more sets of instructions. The term computer-readable medium shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

A limited inventory module may support reservations and sales of limited inventory items using a general computer system as shown in FIG. 1. A user can also accurately verify the availability of limited inventory items in a customer service and support system using a general computer system as shown in FIG. 1. A limited inventory module can also limit the sale of limited inventory items in a customer service and support system using a general computer system as shown in FIG. 1.

A user can verify on an ongoing basis whether a limited inventory item is available. If the limited inventory item is sold, the limited inventory module described herein will be contemporaneously updated and prevent the limited inventory item from being sold again. Of course, in the case of reservations, the limited inventory module may create a priority reservation list (e.g., a waiting list) to allow interested parties to contingently reserve a limited inventory item in case earlier reservations or sales are cancelled.

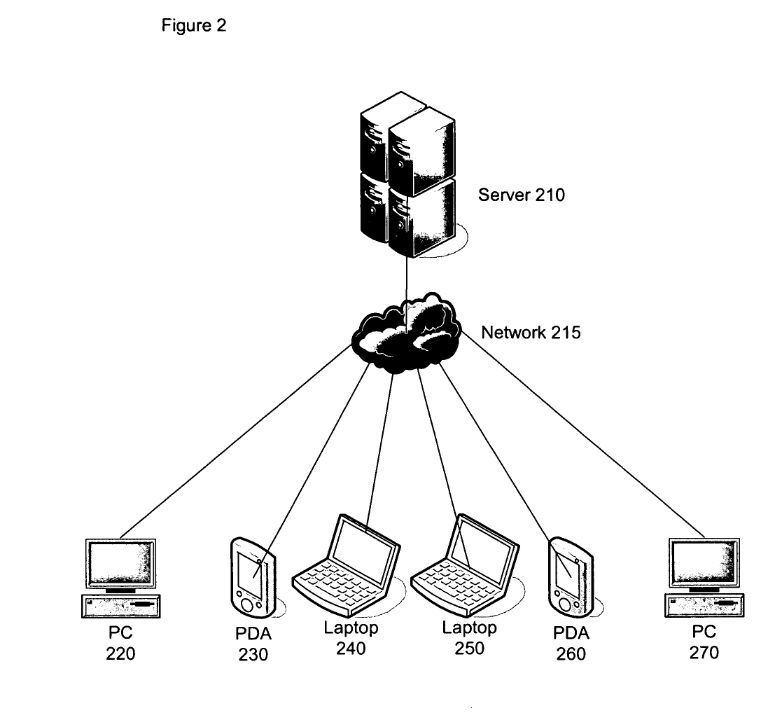

FIG. 2 shows a network for implementing a customer service and support system that includes a limited inventory module for the customer service and support system. As shown, a server 210 is connected to exemplary client devices over a network 215. The exemplary client devices include personal computers (PCs) 220, 270, personal digital assistants (PDAs) 230, 260, and laptops 240, 250. The network 215 may be any type of communications system that allows client devices such as those illustrated to communicate with a server such as that illustrated. The server 210 and any of the exemplary client devices 220-270 may include functionality such as that described for the computer system 100 shown in FIG. 1.

The limited inventory module for a customer service and support system as described herein may be implemented as a computer program running on the client devices 220-270, as a computer program downloaded from the server 210 to the client devices 220-270, and/or as a distributed computer program with all or a portion of the components running on each of the server 210 and various of the client devices 220-270. In another embodiment, the limited inventory module for a customer service and support system as described herein may be implemented in a web-based multi-tiered network.

As described herein, once a sale of a limited inventory item is made, the customer service and support system is updated so as to ensure that the same limited inventory item is not sold a second time to another customer. The limited inventory module allows sales representatives to query the customer service and support system to determine if a limited inventory item is available or likely to become available.

A client device is used to update a centralized system such as the server 210 shown in FIG. 2, and future attempts to sell a limited inventory item may be blocked when the limited inventory item has already been reserved or sold. The client device is used to update a centralized system such as the server 210 shown in FIG. 2, and future inquiries to the centralized system for the limited inventory item may result in information being returned that the limited inventory item is unavailable. Attempts to reserve or sell the limited inventory item may result in the sale or reservation being blocked, or the customer being placed on a prioritized reservation list.

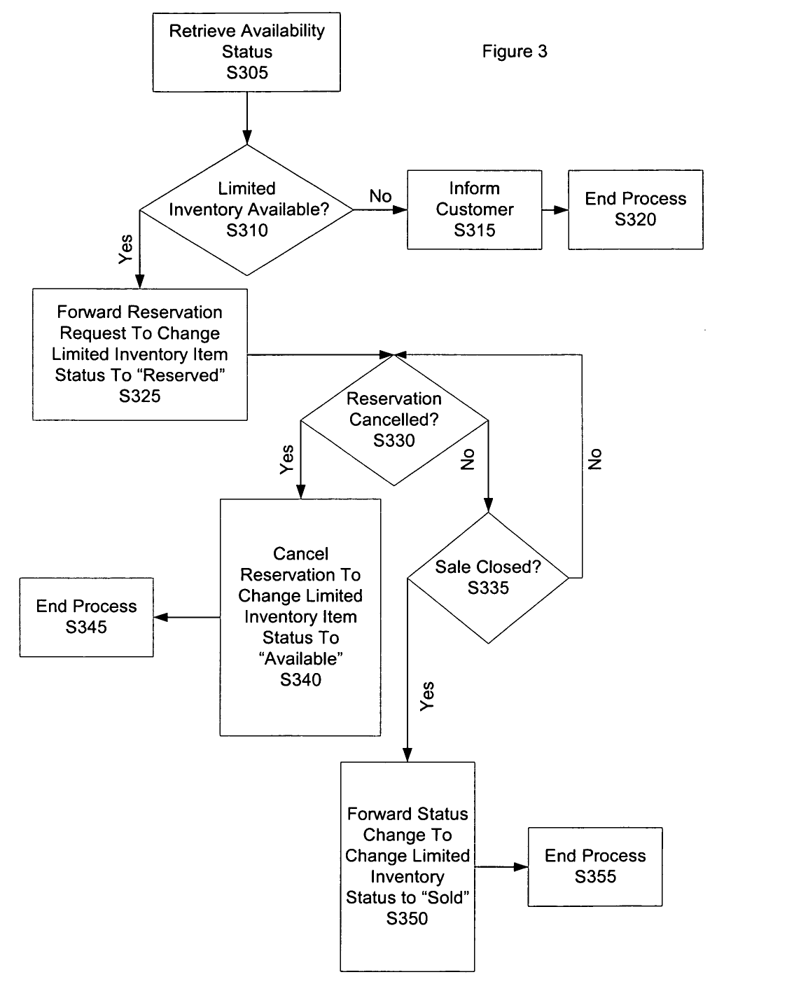

FIG. 3 shows an exemplary method of use for a limited inventory module for a customer service and support system. The exemplary method shown in FIG. 3 is performed by a sales representative to determine whether a limited inventory item is available or likely to become available, and to request a reservation or sale of the limited inventory item when the limited inventory item is available or likely to become available.

As shown, the status of a limited inventory item is retrieved at S305. A determination as to the retrieved status is performed at S310. If the limited inventory item is not available (S310=No), the buyer is informed at S315 and the process ends at S320. If the limited inventory item is available (S310=Yes), a reservation request is forwarded at S325. In an embodiment, a prospective buyer may request to be put on a waitlist before the process ends at S320.

At S330, a determination is made as to whether the reservation should be cancelled. A reservation may be cancelled, for example, at the request of the buyer or upon a determination that the buyer's credit rating is inadequate. If the reservation is not to be cancelled, a determination is made at S335 as to whether the sale is closed. If the sale is not to be closed at S335 (S335=No), the process loops back and a determination is again made as to whether the reservation has been cancelled at S330.

The looping process at S335 and S330 may be provided with a delay so as not to unduly burden processing resources. For example, if the sale is not to be closed at S335 (S335=No), the process may wait for a predetermined amount of time before looping back to check whether the reservation has been cancelled at S330.

If the sale is to be closed at S335 (S335=Yes), a status change request is forwarded at S350 to change the status of the limited inventory item to sold and the process ends at S355. If the reservation request is to be cancelled (S330=Yes), a status change request is forwarded at S340 to cancel the previous reservation request and change the status of the limited inventory item to “available”, after which the process ends at S345. Of course, reference may be made to a waitlist when a reservation is cancelled at S330 (S330=Yes), and a process may be initiated to offer the available item to a prospective buyer on the waitlist.

According to the method shown in FIG. 3, limited inventory advertising for phone directories may be reserved or sold. Regardless of whether a reservation or sale is made in a local or national sales channel, the limited inventory module for a customer service and support system will update the status of the limited inventory item and prevent the limited inventory item from being sold twice. Of course, the limited inventory module is not limited to use for print directories, but may also or alternatively be provided to update status of advertising for online directories.

Sales in a national channel may result in the limited inventory item being sold for all local directories, whereas a local sale will result in the limited inventory item being sold for fewer than all local directories. Even when such sales channels are supported on different systems, sales representatives in either channel can determine when a limited inventory item has been reserved or sold by any sales representative in either channel, and overselling of limited inventory items can be prevented.

Of course, a local sale of the limited inventory item may be subject to conditions. For example, a local sale may be subject to the condition that the sale can be cancelled if the limited inventory item is sold on a national basis, so that information as to whether a previous sale is local or national can be used to determine whether the previous sale can be overridden. As the national sale will be valued at an amount greater than the local sale, the sale on a local level may be contingent on the condition that a sale on a national level is not subsequently received.

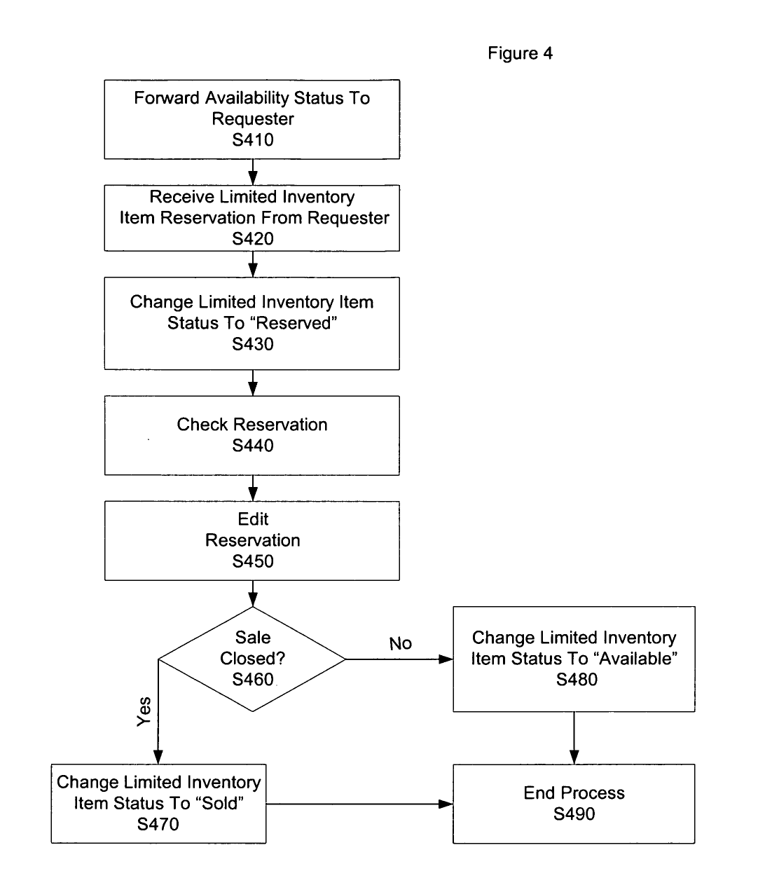

FIG. 4 shows an exemplary method of use for a limited inventory module for a customer service and support system. The exemplary method shown in FIG. 4 is performed automatically and/or by a back-end user using a sales force automation (SFA) tool. The process shown in FIG. 4 is used to inform an inquiring sales representative whether a limited inventory item is available for sale, and to approve and record reservations and sales of the limited inventory item when the limited inventory item is reserved or sold.

A user using a sales force automation tool is authorized to perform the actual updating of the limited inventory module. The process shown in FIG. 4 may also be performed automatically by an interactive computer system, or by an authorized user who remotely accesses the sales force automation tool over a dedicated, secure or private network.

At S410, an availability status is forwarded to a requesting sales representative. At S420, a limited inventory item reservation request is received from the requesting sales representative.

Although not shown, a back-end user may create an entry for a new limited inventory item reservation or sale. A new limited inventory item entry indicates that a limited inventory item was not sold in a previous sales cycle, and default status information was not preset for the limited inventory item. Of course, if an entry for a limited inventory item exists by default from a previous sales cycle, there may be no need to create a new limited inventory item entry in order to approve and record reservations and sales.

At S430, the limited inventory item status is set or changed to “reserve” in response to receiving the request at S420. The reservation is checked at S440 and edited at S450. At S460, a determination is made as to whether a sale has been closed for the limited inventory item. If the sale of the limited inventory item has been closed (S460=Yes), the status of the limited inventory item is set to “sold” at S470. If the sale of the limited inventory item has not been closed (S460=No), the status of the limited inventory item is set to “available” at S480. The change of status to “sold” or “available” after S460 may be in response to a specific instruction or request, or in response to the passing of a predetermined period of time during which a sale must be completed. After the status is changed at S470 or S480, the process ends at S490.

As described above, a sales representative may request that a limited inventory item be reserved. The request may result in the limited inventory item being made unavailable for future sales when the limited inventory module is reserved or sold.

Additionally, the processes described with respect to FIG. 3 and FIG. 4 may be limited to authorized personnel, such that unauthorized sales representatives need to contact the authorized personnel to determine or update the availability status. Further, back-end processes such as those shown for FIG. 4 are sometimes described as batch processes, and may be processes performed by a user at night for all requests. However, the process performed in FIG. 4 may be also be performed in real-time using functionality of a secure or dedicated network that allows multiple authorized agents to access and change statuses of limited inventory items. Additionally, the processes of FIGS. 3 and 4 may be performed by offline users who contact authorized users via, e.g., telephone, to request access to information or a change in status for a limited inventory item.

The entirety of the processes shown in FIGS. 3 and 4 may be performed offline. For example, limited inventory status inquiries and status changes may be performed offline, and status changes may be periodically uploaded to a centralized system such as the server 210 shown in FIG. 2. Alternatively, status changes may be communicated between sales representatives and an authorized support staff member who maintains the limited inventory module.

A process for using the limited inventory module is described below. As is described, the status of limited inventory item availability can be tracked throughout the lifecycle of a sales effort for a product such as a directory issue. Limited inventory item statuses include codes, for example, that inventory is “not limited”, or that inventory is “sold”, “sold for local”, “sold for national”, “sold-right of renewal renewed”, “sold-right of renewal expired”, “sold-other”, “reserved”, “reserved for local sales“, “reserved for national sales”, “waiting” (for confirmation of a status change), “waiting list”, “wait listed”, “pending right of renewal”, “cancelled”, “open” and “available”. Of course, other statuses can be used to indicate the availability status of a limited inventory item, and those listed above are merely exemplary. Specific examples of statuses that may be used in a limited inventory module are explained in detail below.

Pending-ROR (Right of Renewal) is a status that indicates that a buyer purchased a specified item in the previous issue. The previous issue could be the issue that is currently “on the street”, so the previous issue may be known as the “Book On The Street” or BOTS for short. The buyer who purchased a specified item in the previous issue is guaranteed renewal of the purchase unless the renewal is explicitly cancelled by a right of renewal (ROR) date. Therefore, the specified item is reserved for the buyer in the previous year, and any other buyer trying to buy this item is put into a “waiting” status and/or prioritized reservation list.

Sold-R (Sold—Right of Renewal Renewed) is a status that indicates that a buyer specifically agreed to renew the item before the right of renewal date.

Sold-E (Sold—Right of Renewal Expired) is a status that indicates that a buyer has not affirmatively cancelled a limited inventory item before a right of renewal date. Accordingly, the buyer's right of renewal is automatically renewed on the right of renewal date. In particular, the buyer's original contract may specify that the purchase is automatically renewed for the next issue unless the renewal is specifically cancelled. Of course, any other buyer trying to buy this item is put into a “waiting” status and/or prioritized reservation list.

Sold-O (Sold—Other) is a status that indicates 1.) that a specified limited inventory item has been sold to a new customer, or 2.) other circumstances not covered by other statuses.

Sold for National is a status that indicates that a limited inventory item is reserved until a national sales channel can process a sale of an item. National items may be processed in a separate sales channel and by a separate customer service and support system. Therefore, when a limited inventory item is sold to a national customer, the item is reserved for the customer until the system can handle the item.

Open is a status that indicates that a limited inventory item is currently available.

Waiting List is a status that indicates that 1.) a change to another status is pending until a batch process can be run and reservation and/or sale requests can be honored or denied, or 2.) that the item is already sold or pending sale and the customer is on a waitlist for that item. If a batch process runs and a requested limited inventory item is already in a status noted above such as “Pending ROR,” “Sold-R,” “Sold E,” “Sold-O,” or “Sold for National”, or is awarded to another customer with higher priority during the batch process, then a customer is placed into a “waiting” or reservation status. If something happens and the item becomes available, the buyer in the “waiting” or reservation status will be in the queue from which the new “winner” will be chosen.

Force Winner is a status that indicates an item has been awarded to a customer through the “force winner” process. The “force winner” status removes an item from availability.

Additionally, action codes can describe actions leading to the limited inventory item being listed in a table. Action codes include “exists”, “new” and “deleted”. The action code for “exists” indicates that the current edition of a directory already includes the limited inventory item because the limited inventory item was sold to a customer for the current edition of the directory. The action code for “exists” indicates that a right of renewal may be applicable and that the item is not being sold for the first time.

It is also noted that several of the statuses may have the same practical meaning to an inquiring sales representative, but different meanings to billing and accounting tracking systems of the seller. For example, “cancelled” and “open” may both mean that the limited inventory item is available for sale. However, a cancellation carries a particular meaning apart from a general availability, such that a cancelled status conveys information that may be useful to the seller beyond a mere status of “open”.

The process begins when the limited inventory module is to be used and integrated with a customer service and support system. Initially, preexisting tables, which have not previously distinguished limited inventory from unlimited inventory, are updated. The preexisting tables are updated with relevant limited inventory columns and/or rows for tracking limited inventory status.

A preexisting universal directory advertising codes table lists universal directory advertising codes for specified products and marketing families for the family to which each specified product belongs. The universal directory advertising codes table is a generalized table that provides generalized data applicable to different issues and different products, such as Yellow Pages directories across numerous markets and issue periods. The universal directory advertising codes table is updated to include limited inventory status, marketing family, quantity and marketing family units, for each of the items specified in the universal directory advertising codes table.

A limited inventory table is a table for a specific issue of a specific product, such as an upcoming edition of a Yellow Pages directory. The limited inventory table is based upon the generalized information from a universal directory advertising codes table. As is described herein, the limited inventory table may be used to support reservations and sales of limited inventory items. Availability status of limited inventory items can be verified when a sales representative references information in the limited inventory table. Thus, the availability status of a limited inventory item can be tracked and retrieved using a limited inventory table. Further, a sale of a limited inventory item may be prohibited when the limited inventory table indicates that the limited inventory item is not available for sale.

At the beginning of a sales cycle, a right of renewal date is added to existing entries in the limited inventory table to account for customers that have a right to renew the purchase of a product based upon their purchase of the same or a similar product in the previous edition. Such default statuses may be set for existing default entries even before active efforts are made to sell the limited inventory in the new sales cycle. As previous buyers renew or cancel their right of renewal, statuses of existing entries can be updated on an ongoing basis. Further, new entries are added to a limited inventory table before and/or during the sales cycle for limited inventory items that did not appear in a previous limited inventory table.

The first time a limited inventory module is used, a new reference table is created which includes limited inventory exceptions data. The exceptions table includes data for exceptions to predetermined limited item rules that would otherwise apply. For example, an exception may exist for a class of limited inventory items to indicate that right of renewal rules will not apply and that sales of such limited inventory items can be made to new buyers before a right of renewal date that would otherwise apply. Additionally, an exception may exist to indicate that a limited inventory item may be sold in numbers larger than a default. Of course, the exceptions reference table may be updated before or during each product issue sales cycle, such that different exceptions may be created for different circumstances.

After the tables are created and/or updated with new fields, a database interface will run to populate or update the initial limited inventory status for each existing default item in a new limited inventory table. If the item is not limited inventory, the item status will be updated with a code as not-limited inventory. If the item is limited inventory, the default initial status for existing limited inventory items will be updated with a code to indicate an initial default status such as “open” or pending right of renewal. After the initial states are determined prior to the first use of the integrated system, the limited inventory module will support on-going activities automatically and/or based upon user intervention.

The process of preparing a new limited inventory table to support sales efforts of a new product issue begins with pre-canvass preparation. A canvass is a comprehensive effort to sell items, including limited inventory items. In the example of phone directory sales, a canvass is a sales effort directed to selling advertising for an upcoming phone directory release. Initially, all related tables are updated with relevant limited inventory data, such as what limited inventory will be available and an initial default status of each limited inventory item.

In pre-canvass preparation, universal directory advertising codes are rolled-over from the previous issue if applicable. Initial default limited inventory status codes may indicate a default status of “open” or pending right of renewal.

A limited inventory item may be initially available by default when the limited inventory item was not sold in the previous product issue. Additionally, information on previous relationships may be used to provide a right of renewal date. As described above, pending right of renewal status means the customer has not yet renewed or cancelled a contract prior to the right of renewal date.

After pre-canvass preparation, new limited inventory items are created on an ongoing basis for limited inventory items that were not sold in the previous product issue. The user checks availability of a regular limited inventory Item and finds it available. In other words, the user determines that the regular limited item was not sold in the previous product issue, and the limited item is therefore available and not pending right of renewal. The user then populates a new limited inventory item entry for the limited inventory table. A new limited inventory item entry is initially populated by default with an action code of “new”, and a status field is updated to a “reservation” or “sale” status when the limited inventory item is reserved or sold.

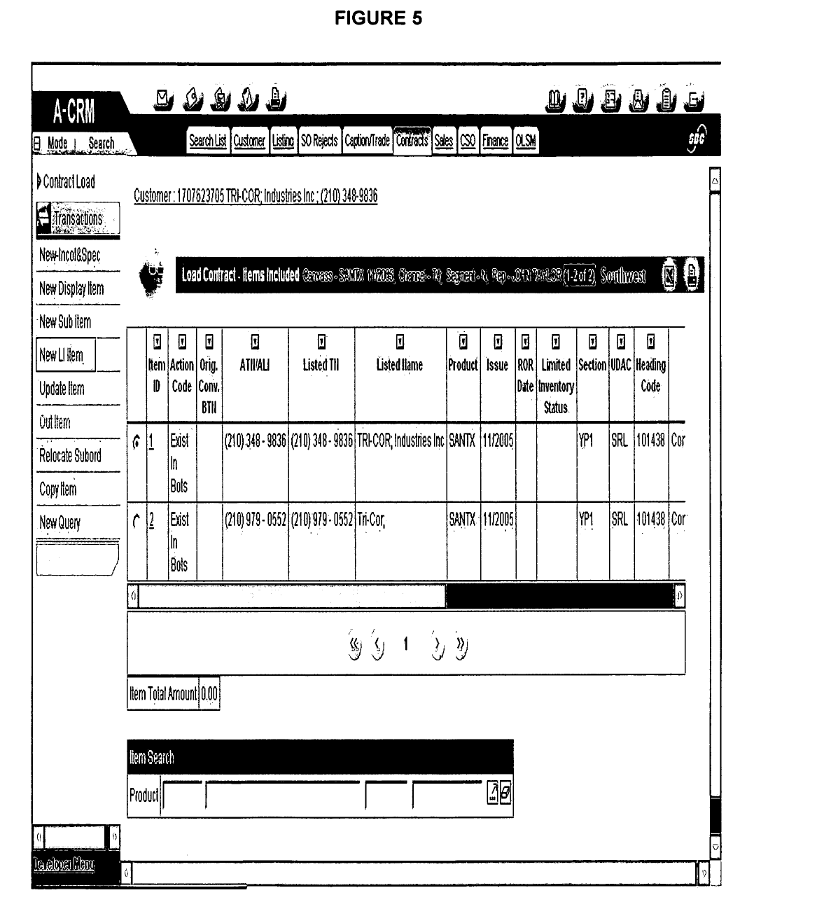

FIG. 5 shows an exemplary screenshot displayed to a user (e.g., a sales representative) using a limited inventory module for a customer service and support system. The two item listings shown in FIG. 5 are generic listings that do not correspond to limited inventory items. As shown, an item list view includes an item identification, an action code, telephone number identifications, a listed name for the customer, a product issue description, a product issue date, a right of renewal date, a limited inventory status, and a universal directory advertising code (UDAC).

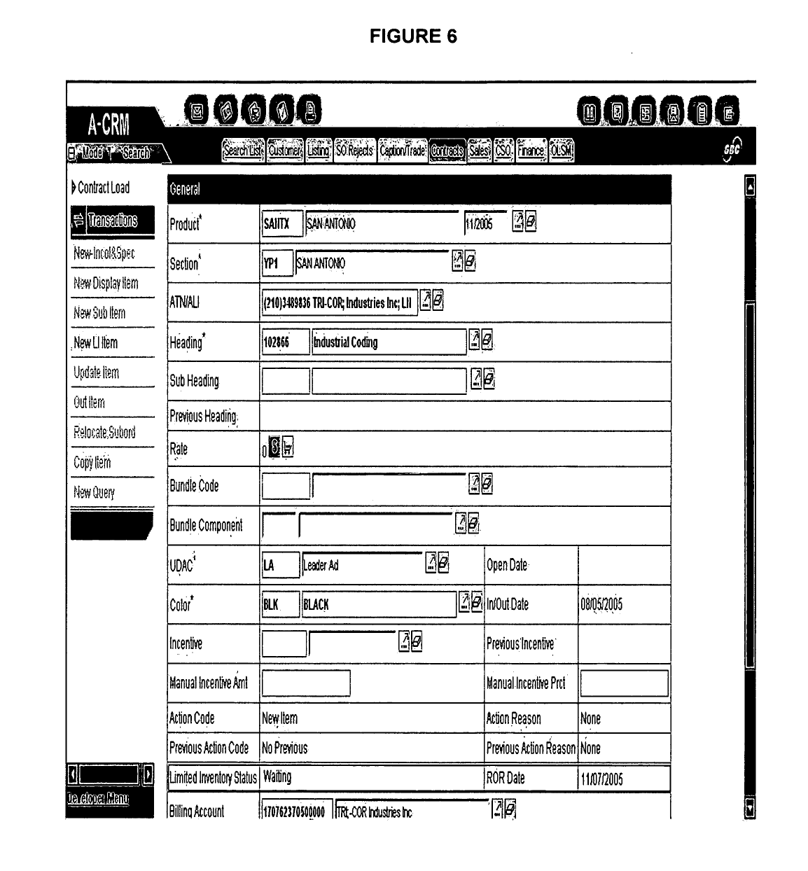

FIG. 6 shows another exemplary screenshot displayed to a user using a limited inventory module for a customer service and support system. As shown in FIG. 6, a sales representative sells a leader ad (e.g., as indicated by the UDAC) as a new item that was not sold in the previous sales cycle and therefore does not have a default status of pending right of renewal for a previous customer. The action code in FIG. 6 shows that the limited inventory item is a “new” item.

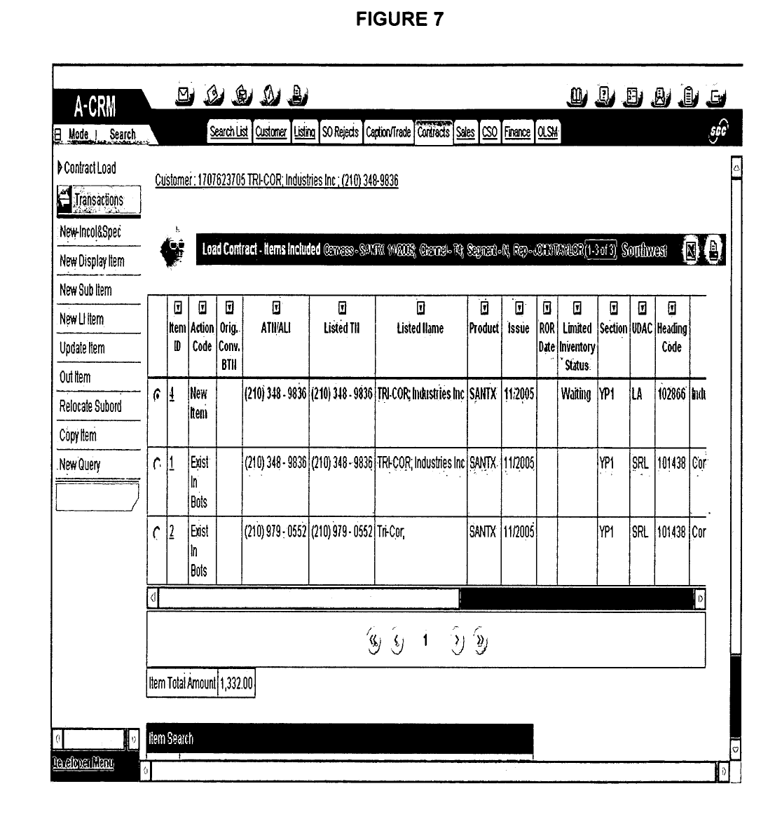

FIG. 7 shows another exemplary screenshot displayed to a user using a limited inventory module for a customer service and support system. The item list view shown in FIG. 7 corresponds to the item list view shown in FIG. 5 with the addition of the “new” item of FIG. 6, shown in the first line of FIG. 7. All items, limited inventory or not, are shown in an item list view in a customer service and support system.

Using the input and information screens described above, statuses may be changed in real-time or near real-time by authorized users with access to a secure private network. Alternatively, statuses may be changed in a batch process by an authorized user. A batch process may take place on a daily (nightly) or other periodic basis so that a single authorized user can review each reservation, sale or other status change requested during the preceding period for limited inventory items.

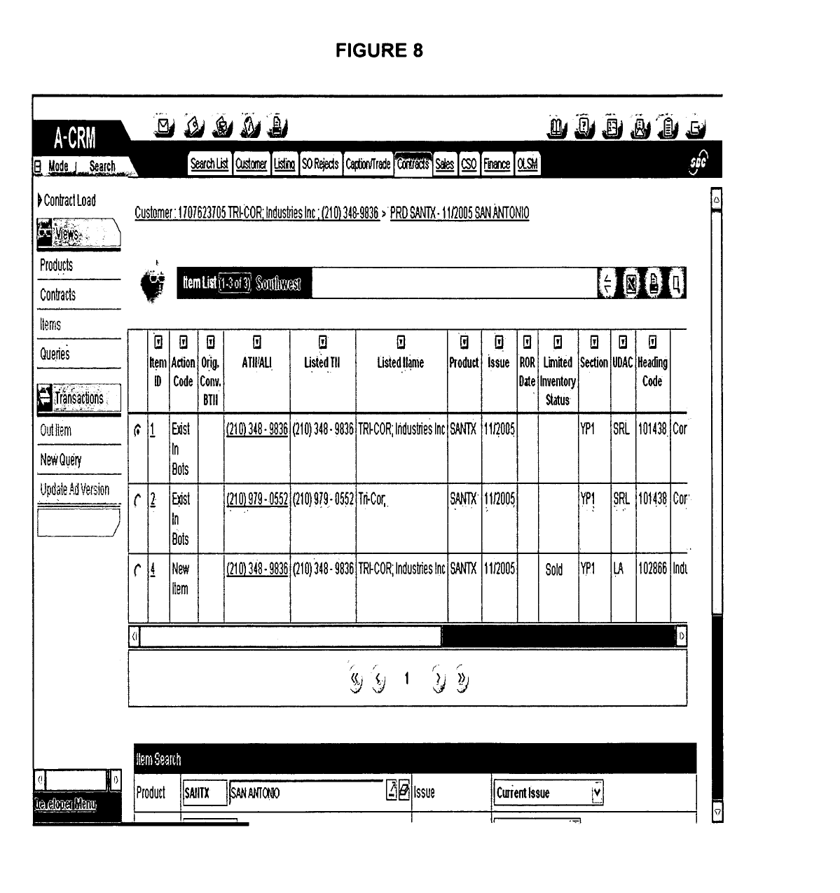

FIG. 8 shows another exemplary screenshot displayed to a user using a limited inventory module for a customer service and support system. In the screenshot of FIG. 8, the limited inventory item status of the “new” item entry shown in FIG. 7 is now shown as “sold,” as indicated by the limited item status column. In other words, the sale of the new limited inventory item in FIG. 7 is approved in an item sold process, and any inquiry as to the status of the new limited inventory item will result in the information that the new limited inventory item is already sold.

An item sold process can be activated during a batch process performed nightly. An item sold process can also be performed by a force/unforce winner transaction.

A limited inventory nightly batch cycle scans entries in a limited inventory application table to see if any reservation or sales request matches any available limited inventory item. If any items are matched, the limited inventory module automatically selects a winner from one or more waiting items according to priority-based limited inventory business rules. The selection of a winner may be made in view of the number of items reserved for a particular sales channel in the limited inventory application table. The result of a batch process changes the limited inventory status of the winning item from “waiting” to “sold”. Alternatively, the result of a batch process may change the limited inventory status of an item from “waiting” to “reserved”.

When a status of an item is changed to “reserved” or “sold”, a memorandum may be sent to a sales representative. For example, a memorandum may be sent when a customer is on a waiting list and the limited inventory item has been awarded. Alternatively, a memorandum may indicate that a customer from the previous year has renewed before the renewal date. The memorandum may also indicate that a particular waiting list item is now available due to a sales or reservation cancellation.

A force/unforce winner transactions process allows an authorized user to force a sale of a limited inventory item. When a status of an item is changed to “sold” by a forced winner transaction, the limited inventory status of the item will change from “waiting” to “sold”. A message may be sent to the user to inform the user that the user is about to force the sale of a limited inventory winner. The message may be a warning to a user to ensure that the user intends to circumvent an automated award system. If a limited inventory item is not available at the time a forced winner transaction is attempted, the user will get a message to unforce another transaction in order to release the limited inventory item. In other words, if a user tries to force a winner for a limited inventory item that has already been awarded, the limited inventory module will require that the user unaward the limited inventory item from another purchase. Of course, the ability to unaward a previously awarded item will only be provided to a limited number of authorized users. The unforce transaction will change the limited inventory status of a sold item from “sold” to “cancelled” on the customer's contract, and from “sold” to “open” as the limited inventory status. Special warnings may be provided to a user when a completed transaction is unforced using the limited inventory module.

Tables are updated when a contract is cancelled by either a buyer or seller. When a limited inventory contract is cancelled, notation may be made that the sale of the limited inventory item is cancelled such that the limited inventory item is available. The cancellation transaction is available only for authorized users and will allow the user to cancel transactions for a limited inventory item in predetermined circumstances. Limited inventory items with other statuses (e.g., “waiting”) can be cancelled at the request of the original requesting sales representative when the transaction is not yet completed in the system.

Examples of updating statuses are described below. Initially, in pre-canvass preparation, an entry for customer A is given an action code of “exists” to indicate that a contract for a specified limited inventory item already exists in the system. The entry for customer A is given a limited inventory status of pending right of renewal to indicate that the item is pending customer A's right of renewal. On a later date, an entry for a customer B is given an action code of “new” to indicate that the entry for a specified limited inventory item is new. The entry for customer B is initially populated with a limited inventory status of “waiting” when a sales representative initially requests reservation or sale of the limited inventory item, and is changed to “reserved” or “sold” when the transaction is approved.

When customer A cancels, the action code for the entry for customer A is changed to “deleted” and the limited inventory status is changed to “waiting” until processing for the cancellation is completed. When customer B cancels, the limited inventory status for the entry for customer B is changed to “cancelled”. If customer A does not cancel, the limited inventory item status for customer A is changed to “sold-exists” on the right of renewal date to indicate that the limited inventory item is sold to customer A since customer A has not cancelled the contract.

In a second example, in pre-canvass preparation an entry for customer A shows that a contract for a specified item is pending right of renewal. Accordingly, the initial action code is “exists”. On a subsequent date customer A affirmatively renews the contract, so the limited item status is shown as “sold-renewed”. When an authorized user cancels customer A's limited inventory item for any reason, the action code is shown as “deleted”, and the limited inventory item is updated to “waiting” until processing for the item cancellation is completed. On a subsequent date, the limited inventory item for customer A is reinstated and the action code is again shown as “exists”.

As described above, the limited inventory module allows sales representatives to query a customer service and support system to see if a limited inventory item is available or likely to become available soon. Limited inventory items can then be pitched according to the available information. Sale and reservation information can be used to update the customer service and support system, thereby ensuring that other sales representatives do not oversell a limited inventory item which has already been sold or reserved. Of course, exceptions to sales and reservation limitations are available to authorized personnel as described above.

The limited inventory module may eliminate last-minute manual work now required to remove oversold items. The limited inventory module also allows management to accurately project revenue and see what items are sold/unsold. Because the limited inventory module shortens the time between checking for availability and reserving the item for the customer, and because it prevents oversold conditions, the confidence of sales representatives in pitching and selling limited inventory items can be raised, resulting in increases in items sold and revenue. Since the representative will know in real time if an item is not available, the representative can pitch something else to the customer and retain the revenue for the seller. The limited inventory module also helps eliminate credits to customers when exclusive items are oversold in violation of agreements.

Using the limited inventory module, sales managers are provided with accurate information as to revenue derived in a sales effort, as well as availability of limited inventory items. As a result, sales resources can be redirected on an ongoing basis to those limited inventory items which are not yet sold.

Although the limited inventory module described herein may be provided as a standalone device or program, the limited inventory module may also be integrated with a comprehensive software suite such that it coordinates orders, publishing, billing and any other activities related to a business. Further, although exemplary business rules are described herein, the business rules implemented by a limited inventory module are not limited to those described. Rather, business rules implemented for a limited inventory module can be changed in accordance with the goals of a business using the limited inventory module.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term invention merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

For example, the limited inventory module can be used by any company which sells limited inventory items, as well as any company that provides a customer service and support system used to sell limited inventory items.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

What is claimed is:

1. A method of coordinating sales of limited directory advertising space, comprising:
obtaining an indication of an availability status of the limited directory advertising space;
receiving an order for the limited directory advertising space;
accepting the order for the limited directory advertising space when the availability status indicates that the limited directory advertising space is available and refusing the order for the limited directory advertising space when the availability status indicates that the limited directory advertising space is unavailable, and
changing the availability status for the limited directory advertising space when the order is accepted.

2. The method of coordinating sales of claim 1,
wherein the availability status is changed to a reserved status when an order is initially accepted.

3. The method of coordinating sales of claim 2, further comprising:
confirming acceptance of the accepted order for the limited directory advertising space.

4. The method of coordinating sales of claim 3, further comprising:
changing the availability status to an unavailable status when the accepted order for the limited directory advertising space is confirmed as accepted.

5. The method of coordinating sales of claim 3,
wherein the acceptance of the accepted order is confirmed when the order is placed earlier than another order for the limited directory advertising space.

6. The method of coordinating sales of claim 1,
wherein the limited directory advertising space comprises advertising capacity for a printed periodical.

7. The method of coordinating sales of claim 1,
wherein the availability status of the limited directory advertising space is retrieved using a machine capable of executing a set of instructions.

8. The method of coordinating sales of claim 1,
wherein the indication of the availability status of the limited directory advertising space is displayed on a user interface.

9. The method of coordinating sales of claim 1,
wherein the directory comprises a telephone directory.

10. The method of coordinating sales of claim 1,
wherein the indication of the availability status is retrieved from a server by a client, and
wherein the order for the limited directory advertising space is sent to the server from the client.

11. The method of coordinating sales of claim 10,
wherein the server is configured to accept orders for the limited directory advertising space from any of a plurality of predetermined clients.

12. The method of coordinating sales of claim 11,
wherein the server limits acceptance of orders to the plurality of predetermined clients.

13. The method of coordinating sales of claim 1,
wherein the order for the limited directory advertising space is accepted based upon a comparison of a plurality of orders and a determination as to which order to accept based on predetermined criteria indicating a priority of each of the plurality of orders.

14. The method of coordinating sales of claim 1,
wherein a sale in a first class is made on the condition that an offer for sale in a second class is not received.

15. The method of coordinating sales of claim 14,
wherein the first class of sales comprises sales in a first geographic area, and
wherein the second class of sales comprises sales in a second geographic area larger than and including the first geographic area.

16. The method of coordinating sales of claim 14,
wherein the first class of sales comprises sales at a first compensation amount, and
wherein the second class of sales comprises sales at a second compensation amount greater than the first compensation amount.

17. The method of coordinating sales of claim 1,
wherein an order for the limited directory advertising space is not accepted when the limited directory advertising space is reserved pending a right of renewal for a previous customer.

18. The method of coordinating sales of claim 1, further comprising:
initially changing a status of the limited directory advertising space to a waiting status until a request to change the status of the limited directory advertising space is approved.

19. The method of coordinating sales of claim 1, further comprising:
populating a waiting list for the limited inventory item when the limited inventory item is unavailable and another order for the limited inventory item is received.

20. A computer readable medium for storing a program that coordinates sales of limited directory advertising space, comprising:
a limited directory advertising space availability forwarding segment for forwarding an indication of an availability status of the limited directory advertising space;
an order receiving segment for receiving an order for the limited directory advertising space;
an order placement acceptance segment for accepting the order for the limited directory advertising space when the availability status indicates that the limited directory advertising space is available and for refusing the order for the limited directory advertising space when the availability status indicates that the limited directory advertising space is unavailable, and
a status changing segment for changing the availability status for the limited directory advertising space when the order is accepted.

21. A limited inventory module for a customer service and support system for coordinating sales of limited directory advertising space, comprising:
a forwarder that forwards an indication of an availability status of the limited directory advertising space;
a receiver that receives an order for the limited directory advertising space;
an acceptor that accepts the order for the limited directory advertising space when the availability status indicates that the limited directory advertising space is available and that refuses the order for the limited directory advertising space when the availability status indicates that the limited directory advertising space is unavailable, and
a status changer that changes the availability status for the limited directory advertising space when the order is accepted.
